(19) United States
(12) Patent Application Publication
(10) Pub. No.: US 2026/0128679 A1
(43) Pub. Date: May 7, 2026

(54) POWER SUPPLY CIRCUIT HAVING POSITIVE AND NEGATIVE OUTPUT VOLTAGES

(71) Applicant: LITE-ON TECHNOLOGY CORPORATION, TAIPEI CITY (TW)

(72) Inventor: Chih-Shan Chen, TAIPEI CITY (TW)

(21) Appl. No.: 19/026,120

(22) Filed: Jan. 16, 2025

(30) Foreign Application Priority Data
Nov. 5, 2024 (CN) 202411562763.5

(51) Int. Cl. H02M 3/335; H02M 1/00; H02M 1/32; H02M 1/42; H02M 1/44; H02M 3/00

(52) U.S. Cl. CPC H02M 3/33561; H02M 1/0064; H02M 1/32; H02M 1/42; H02M 1/44; H02M 3/01; H02M 3/33571; H02M 3/33576

(57) ABSTRACT

A power supply circuit having positive and negative output voltages is provided. The power supply circuit includes a primary side circuit, a transformer, and a secondary side circuit. The primary side circuit includes a resonant converter. The transformer includes a primary side winding and a secondary side winding. The secondary side circuit includes a positive voltage output circuit and a negative voltage output circuit. The resonant converter is connected to the primary side winding. The positive voltage output circuit and the negative voltage output circuit are connected to the secondary side winding. The positive voltage output circuit is configured to output a positive output voltage, and the negative voltage output circuit is configured to output a negative output voltage.

### CROSS-REFERENCE TO RELATED PATENT APPLICATION

This application claims the benefit of priority to China Patent Application No. 202411562763.5, filed on Nov. 5, 2024. The entire content of the above identified application is incorporated herein by reference.

Some references, which may include patents, patent applications and various publications, may be cited and discussed in the description of this disclosure. The citation and/or discussion of such references is provided merely to clarify the description of the disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The disclosure relates to a power supply circuit, and more particularly to a power supply circuit having positive and negative output voltages.

### BACKGROUND OF THE DISCLOSURE

Resonant converters are indispensable for electronic devices. Resonant converters such as inductor-inductor-capacitor (LLC) resonant converters are used to convert direct current (DC) input voltages into DC output voltages. However, conventional resonant converters are only capable of converting a single input voltage that may have a positive voltage value. Conventional resonant converters are unable to supply both the output voltage having the positive voltage value and an output voltage having a negative voltage value at the same time. Therefore, the conventional resonant converters are unsuitable for many applications.

### SUMMARY OF THE DISCLOSURE

In response to the above-referenced technical inadequacies, the disclosure provides a power supply circuit having positive and negative output voltages. The power supply circuit includes a primary side circuit, a transformer and a secondary side circuit. The primary side circuit includes a resonant converter. The transformer includes a primary side winding and a secondary side winding. The resonant converter is connected to the primary side winding. The secondary side circuit includes a positive voltage output circuit and a negative voltage output circuit. The positive voltage output circuit is connected to the secondary side winding. The positive voltage output circuit is configured to output a positive output voltage. The negative voltage output circuit is connected to the secondary side winding. The negative voltage output circuit is configured to output a negative output voltage.

As described above, the disclosure provides the power supply circuit having the positive and negative output voltages. In comparison with a conventional power converter that is only capable of supplying the positive output voltage, the power supply circuit of the disclosure is capable of supplying the positive output voltage and the negative output voltage at the same time. Therefore, the power supply circuit of the disclosure is more widely applicable than the conventional power converter.

These and other aspects of the disclosure will become apparent from the following description of the embodiments taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a power supply circuit having positive and negative output voltages according to a first embodiment of the disclosure;

FIG. 2 is a circuit diagram of a power supply circuit having positive and negative output voltages according to a second embodiment of the disclosure;

FIG. 3 is a circuit diagram of a power supply circuit having positive and negative output voltages according to a third embodiment of the disclosure;

FIG. 4 is a circuit diagram of a power supply circuit having positive and negative output voltages according to a fourth embodiment of the disclosure;

FIG. 5 is a circuit diagram of a power supply circuit having positive and negative output voltages according to a fifth embodiment of the disclosure;

FIG. 6 is a circuit diagram of a power supply circuit having positive and negative output voltages according to a sixth embodiment of the disclosure; and

FIG. 7 is a circuit diagram of a power supply circuit having positive and negative output voltages according to a seventh embodiment of the disclosure.

### DETAILED DESCRIPTION OF THE EXEMPLARY EMBODIMENTS

The disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the disclosure.

The terms used herein generally have their ordinary meanings in the art. In the case of conflict, the disclosure, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the disclosure or of any exemplified term. Likewise, the disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

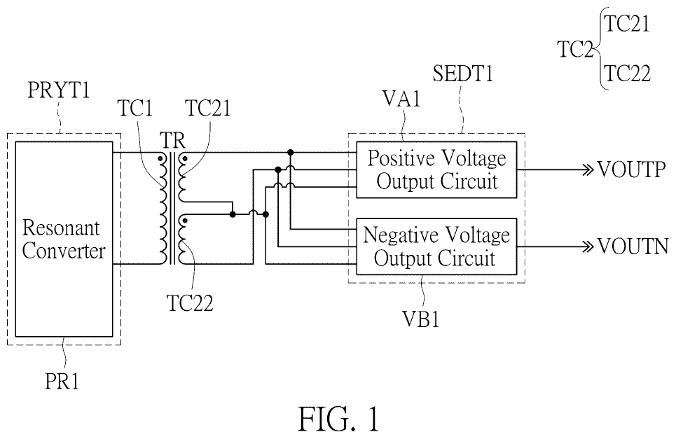

Reference is made to FIG. 1, which is a circuit diagram of a according to a first embodiment of the disclosure.

As shown in FIG. 1, in first embodiment, the power supply circuit of the disclosure includes a primary side circuit PRYT1, a transformer TR and a secondary side circuit SEDT1.

The primary side circuit PRYT1 includes a resonant converter PR1. For example, the resonant converter PR1 may be an inductor-inductor-capacitor (LLC) resonant converter, but the disclosure is not limited thereto.

It is worth noting that, in the power supply circuit of the first embodiment of the disclosure, the secondary side circuit SEDT1 not only includes a positive voltage output circuit VA1, but also includes a negative voltage output circuit VB1.

The transformer TR includes a primary side winding TC1 and a secondary side winding TC2. The secondary side winding TC2 may include a first secondary side subwinding TC21 and a second secondary side subwinding TC22. The transformer TR may further include a magnetic core, and the primary side winding TC1 and the secondary side winding TC2 may be wound around the magnetic core of the transformer TR. The primary side winding TC1 of the transformer TR is connected to an output terminal of the resonant converter PR1.

The first secondary side subwinding TC21 and the second secondary side subwinding TC22 of the transformer TR are connected to the positive voltage output circuit VA1 and the negative voltage output circuit VB1.

The positive voltage output circuit VA1 outputs a positive output voltage VOUTP having a positive value according to a plurality of secondary side voltages from the first secondary side subwinding TC21 and the second secondary side subwinding TC22 of the transformer TR.

The negative voltage output circuit VB1 outputs a negative output voltage VOUTN having a negative value according to a plurality of secondary side voltages from the first secondary side subwinding TC21 and the second secondary side subwinding TC22 of the transformer TR.

The power supply circuit of the disclosure has two output terminals that are a positive voltage output terminal and a negative voltage output terminal. The positive voltage output terminal of the power supply circuit of the disclosure outputs the positive output voltage VOUTP. The power supply circuit of the disclosure outputs the negative output voltage VOUTN. Therefore, the power supply circuit of the disclosure is suitable for many applications.

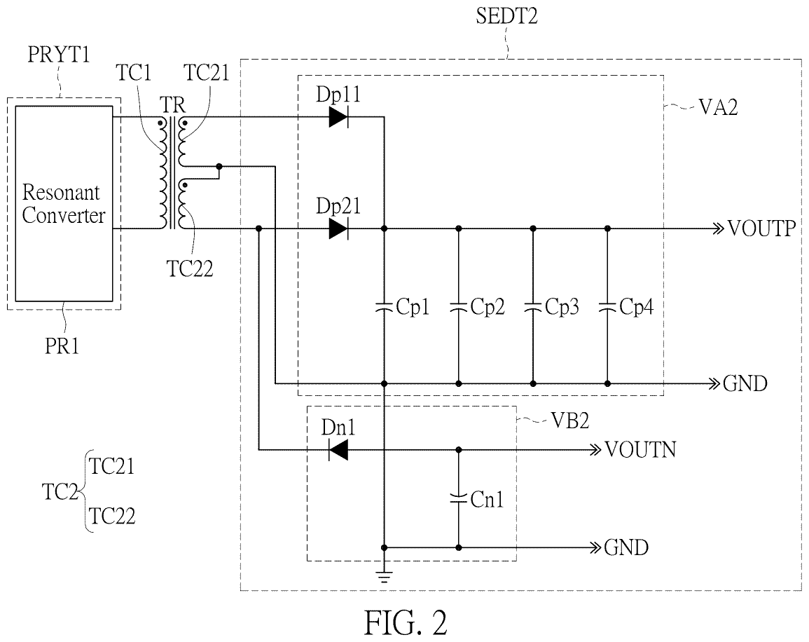

Reference is made to FIG. 2, which is a circuit diagram of a according to a second embodiment of the disclosure.

The descriptions of the second embodiment that are the same as the descriptions of the first embodiment are not repeated herein.

As shown in FIG. 2, in the second embodiment, the power supply circuit of the disclosure includes the primary side circuit PRYT1, the transformer TR and a secondary side circuit SEDT2.

It is worth noting that, in the power supply circuit of the second embodiment of the disclosure, the secondary side circuit SEDT2 not only includes a positive voltage output circuit VA2, but also includes a negative voltage output circuit VB2.

In the second embodiment, as shown in FIG. 2, the positive voltage output circuit VA2 includes a plurality of output capacitors Cp1 to Cp4, and one or more unidirectional conduction components such as a first diode Dp11 and a second diode Dp21.

An anode of the first diode Dp11 is connected to a first terminal of the first secondary side subwinding TC21. An anode of the second diode Dp21 is connected to a second terminal of the second secondary side subwinding TC22. A cathode of the first diode Dp11 and a cathode of the second diode Dp21 are connected to a first terminal of each of the plurality of output capacitors Cp1 to Cp4. A second terminal of the first secondary side subwinding TC21, a first terminal of the second secondary side subwinding TC22 and a second terminal of each of the plurality of output capacitors Cp1 to Cp4 are connected to a ground GND.

Voltage of each output capacitor of the plurality of output capacitors Cp1 to Cp4 have the same voltage value. The voltage of the first terminal of any output capacitor of the plurality of output capacitors Cp1 to Cp4 is used as the positive output voltage VOUTP of the power supply circuit of the second embodiment of the disclosure.

It is worth noting that, in the second embodiment, as shown in FIG. 2, the negative voltage output circuit VB2 includes an inverter capacitor Cn1 and a first inverter diode Dn1. The inverter capacitor Cn1 is a capacitor. The first inverter diode Dn1 is a diode.

A cathode of the first inverter diode Dn1 is connected to the second terminal of the second secondary side subwinding TC22 of the transformer TR. An anode of the first inverter diode Dn1 is connected to a first terminal of the inverter capacitor Cn1. A second terminal of the inverter capacitor Cn1 is connected to the ground GND.

A voltage of the first terminal of the inverter capacitor Cn1 is used as the negative output voltage VOUTN of the power supply circuit of the second embodiment of the disclosure. The negative output voltage VOUTN has a negative voltage value. A voltage of the second terminal of the second secondary side subwinding TC22 of the transformer TR is half-wave rectified to form the negative output voltage VOUTN by the inverter capacitor Cn1 and the first inverter diode Dn1 of the negative voltage output circuit VB2.

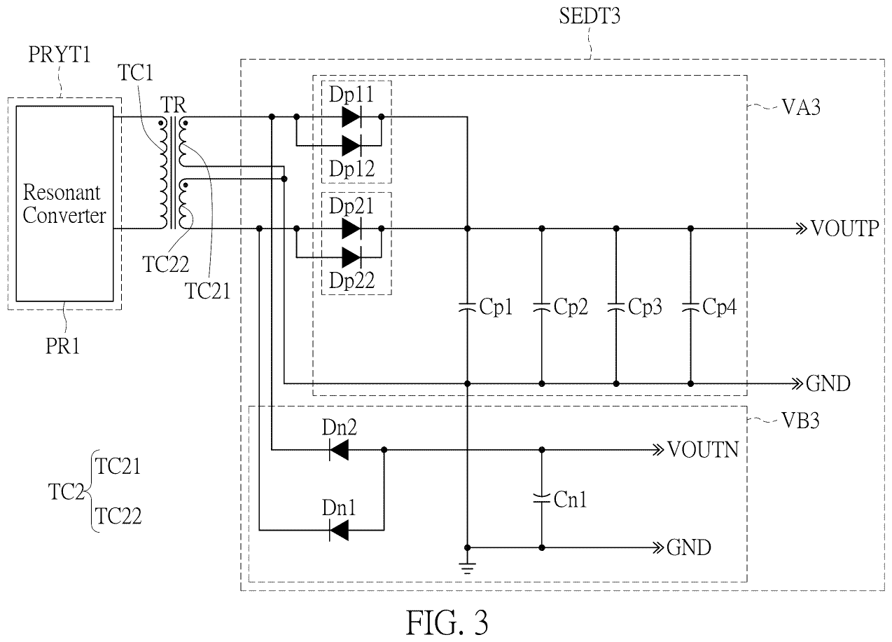

Reference is made to FIG. 3, which is a circuit diagram of a according to a third embodiment of the disclosure.

The descriptions of the third embodiment that are the same as the descriptions of the disclosure are not repeated herein.

A difference between the third and second embodiments is that, as shown in FIG. 3, in the power supply circuit of the third embodiment of the disclosure, a positive voltage output circuit VA3 includes the first diode Dp11, a first diode Dp12, the second diode Dp21 and a second diode Dp22, and in particular, a negative voltage output circuit VB3 includes the first inverter diode Dn1 and a second inverter diode Dn2.

The plurality of first diodes Dp11, Dp22 (and more diodes in practice) are connected in parallel with each other. An anode of the first diode Dp12 is connected to the first terminal of the first secondary side subwinding TC21. A cathode of the first diode Dp12 is connected to the first terminal of each output capacitor of the plurality of output capacitors Cp1 to Cp4.

The plurality of second diodes Dp11, Dp22 (and more diodes in practice) are connected in parallel with each other. An anode of the second diode Dp22 is connected to the second terminal of the second secondary side subwinding TC22. A cathode of the second diode Dp22 is connected to the first terminal of each output capacitor of the plurality of output capacitors Cp1 to Cp4.

The number of first diodes and second diodes that are included in the power supply circuit of the disclosure may depend on practical requirements, and the disclosure is not limited thereto.

A cathode of the second inverter diode Dn2 is connected to the first terminal of the first secondary side subwinding TC21. An anode of the second inverter diode Dn2 is connected to the first terminal of the inverter capacitor Cn1. A voltage of the secondary side winding TC2 of the transformer TR is full-wave rectified to form the negative output voltage VOUTN by the inverter capacitor Cn1, the first inverter diode Dn1 and the second inverter diode Dn2 of the negative voltage output circuit VB3.

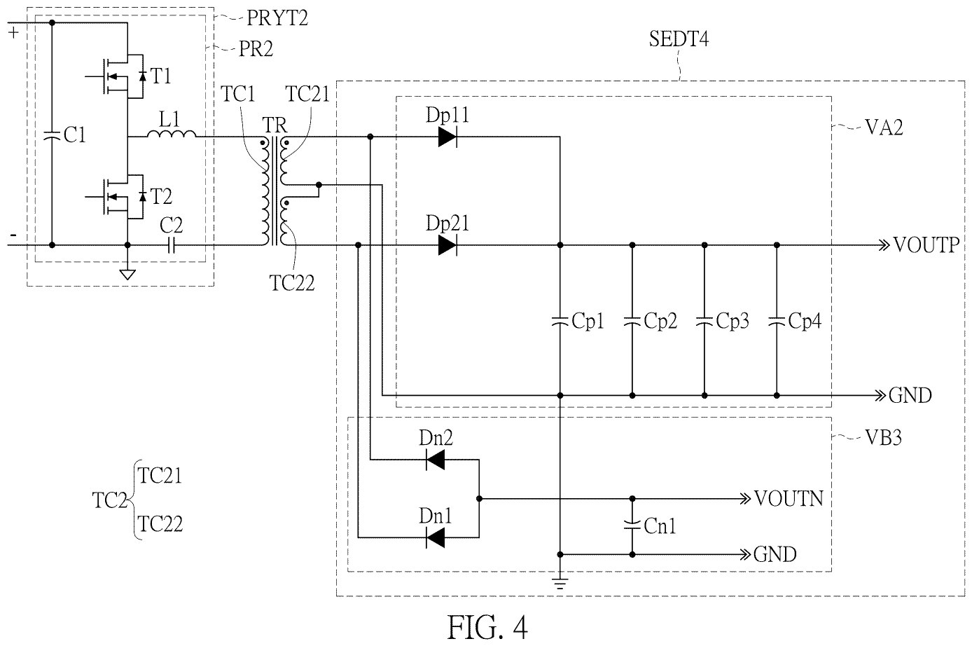

Reference is made to FIG. 4, which is a circuit diagram of a according to a fourth embodiment of the disclosure.

In the fourth embodiment, the power supply circuit of the disclosure includes a primary side circuit PRYT2, the transformer TR and a secondary side circuit SEDT4.

The secondary side circuit SEDT4 includes the positive voltage output circuit VA2 and the negative voltage output circuit VB3. The positive voltage output circuit VA2 shown in FIG. 4 is the same as the positive voltage output circuit VA2 shown in FIG. 2. The negative voltage output circuit VB3 shown in FIG. 4 is the same as negative voltage output circuit VB3 shown in FIG. 3.

The primary side circuit PRYT1 shown in FIG. 1 to FIG. 3 may be replaced with the primary side circuit PRYT2 shown in FIG. 4.

As shown in FIG. 4, the primary side circuit PRYT2 includes a resonant converter PR2. The resonant converter PR2 includes a high-side transistor T1, a low-side transistor T2, an input inductor L1, a first input capacitor C1 and a second input capacitor C2. In practice, the resonant converter PR2 may include more high-side transistors and low-side transistors.

As shown in FIG. 4, a first terminal of the first input capacitor C1 is connected to a positive terminal of an external input power source (that is not shown in figures). A second terminal of the first input capacitor C1 is connected to a negative terminal of the external input power source.

A first terminal of the high-side transistor T1 is connected to the positive terminal of an external input power source and the first terminal of the first input capacitor C1. A second terminal of the high-side transistor T1 is connected to a first terminal of the low-side transistor T2. A second terminal of the low-side transistor T2 is connected to the negative terminal of the external input power source and the second terminal of the first input capacitor C1. A node between the second terminal of the high-side transistor T1 and the first terminal of the low-side transistor T2 is connected to a first terminal of the input inductor L1.

A first terminal of the primary side winding TC1 of the transformer TR is connected to a second terminal of the input inductor L1. A second terminal of the primary side winding TC1 of the transformer TR is connected to a first terminal of the second input capacitor C2. A second terminal of the second input capacitor C2 is connected to the negative terminal of the external input power source.

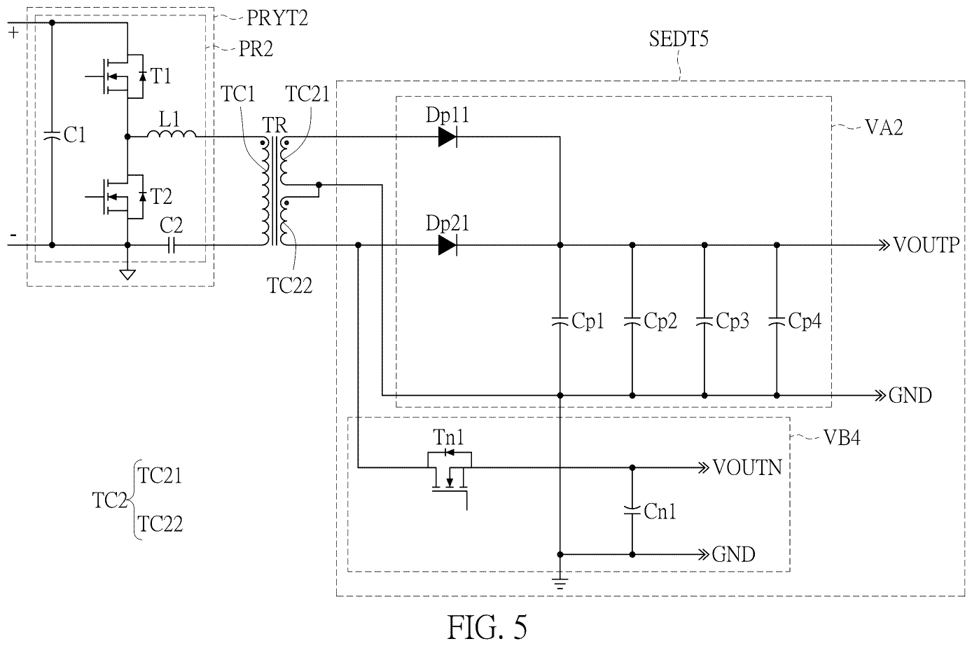

Reference is made to FIG. 5, which is a circuit diagram of a according to a fifth embodiment of the disclosure.

In the fifth embodiment, the power supply circuit of the disclosure includes the primary side circuit PRYT2, the transformer TR and a secondary side circuit SEDT5.

The secondary side circuit SEDT5 includes the positive voltage output circuit VA2 and a negative voltage output circuit VB4. The positive voltage output circuit VA2 shown in FIG. 5 is the same as the positive voltage output circuit VA2 shown in FIG. 2 and FIG. 4. The primary side circuit PRYT2 shown in FIG. 5 is the same as the primary side circuit PRYT2 shown in FIG. 4.

A difference between the fifth and fourth embodiments of the disclosure is that, in the fifth embodiment, the negative voltage output circuit VB4 of the power supply circuit of the disclosure includes the inverter capacitor Cn1 and a first transistor Tn1. In practice, the first transistor Tn1 shown in FIG. 5 may be replaced with other types of transistors or switch components.

A first terminal of the first transistor Tn1 is connected to the second terminal of the second secondary side subwinding TC22. A second terminal of the first transistor Tn1 is connected to the first terminal of the inverter capacitor Cn1. A second terminal of the inverter capacitor Cn1 is connected to the ground GND.

A control terminal of the first transistor Tn1 is coupled to a first control voltage, or is connected to an external control circuit and receives a first control voltage signal having the first control voltage from the external control circuit. The first transistor Tn1 operates according to the first control voltage.

In the fifth embodiment, the voltage of the secondary side winding TC2 of the transformer TR is half-wave rectified to form the negative output voltage VOUTN by the inverter capacitor Cn1 and the first transistor Tn1 of the negative voltage output circuit VB4. The voltage of the first terminal of the inverter capacitor Cn1 is used as the negative output voltage VOUTN. The voltage of one output capacitor of the plurality of output capacitors Cp1 to Cp4 is used as the positive output voltage VOUTP.

That is, the power supply circuit of the disclosure not only supplies the positive output voltage VOUTP having the positive voltage value, but also supplies the negative output voltage VOUTN having the negative voltage value. Therefore, the power supply circuit of the disclosure is suitable for many applications.

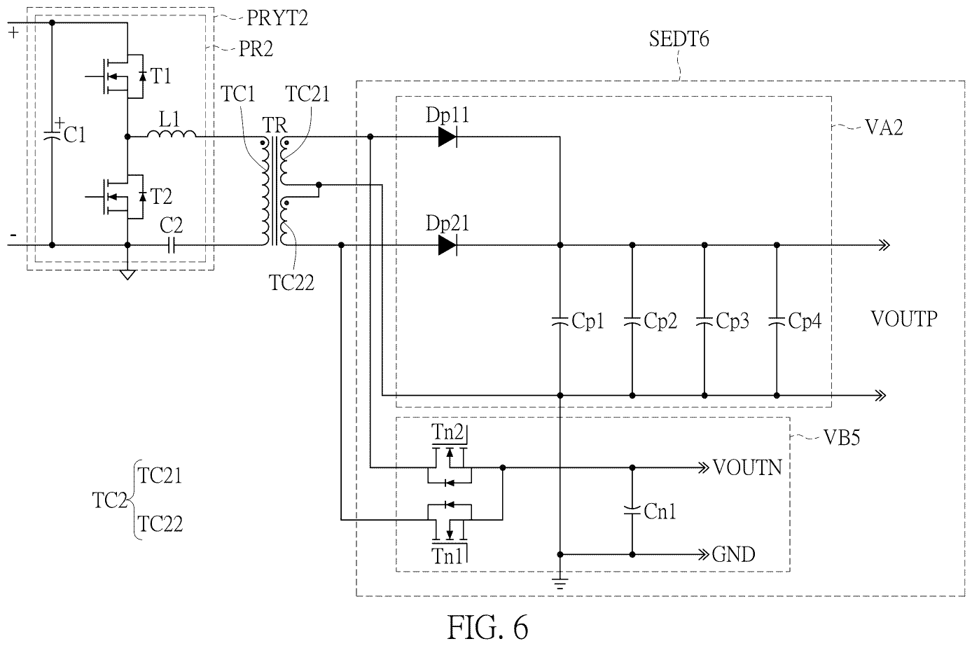

Reference is made to FIG. 6, which is a circuit diagram of a according to a sixth embodiment of the disclosure.

A difference between a negative voltage output circuit VB5 included in secondary side circuit SEDT6 of the power supply circuit as shown in FIG. 6 and the negative voltage output circuit VB4 included in the secondary side circuit SEDT5 of the power supply circuit as shown in FIG. 5 is that, the negative voltage output circuit VB5 not only includes the first transistor Tn1, but also includes a second transistor Tn2. In practice, the second transistor Tn2 shown in FIG. 6 may be replaced with other types of transistors or switch components.

A first terminal of the second transistor Tn2 is connected to the first terminal of the first secondary side subwinding TC21. A second terminal of the second transistor Tn2 is connected to the first terminal of the inverter capacitor Cn1. A second terminal of the inverter capacitor Cn1 is connected to the ground GND.

A control terminal of the second transistor Tn2 is coupled to a second control voltage, or is connected to the external control circuit and receives a second control voltage signal having the second control voltage from the external control circuit. The second transistor Tn2 operates according to the second control voltage.

In the sixth embodiment, the voltage of the secondary side winding TC2 of the transformer TR is full-wave rectified to form the negative output voltage VOUTN by the inverter capacitor Cn1, the first transistor Tn1 and the second transistor Tn2 of the negative voltage output circuit VB5. The voltage of the first terminal of the inverter capacitor Cn1 is used as the negative output voltage VOUTN.

That is, the power supply circuit of the disclosure not only supplies the positive output voltage VOUTP having the positive voltage value, but also supplies the negative output voltage VOUTN having the negative voltage value. Therefore, the power supply circuit of the disclosure is suitable for many applications.

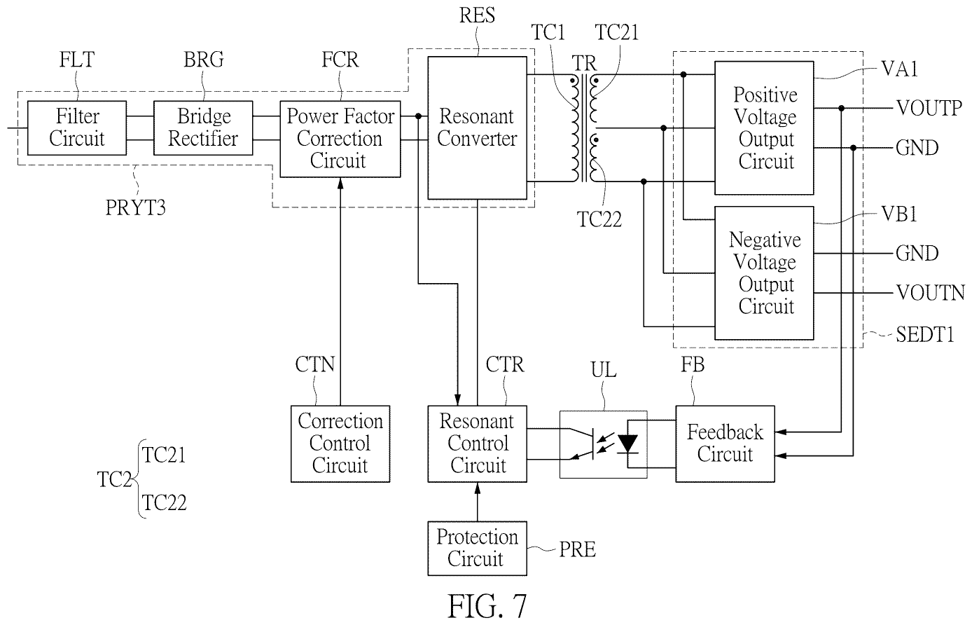

Reference is made to FIG. 7, which is a circuit diagram of a according to a seventh embodiment of the disclosure.

As shown in FIG. 7, in the seventh embodiment, the power supply circuit of the disclosure includes a primary side circuit PRYT3, the transformer TR, the secondary side circuit SEDT1, a feedback circuit FB, a coupling circuit UL, a resonant control circuit CTR, a protection circuit PRE and a correction control circuit CTN.

The secondary side circuit SEDT1 includes the positive voltage output circuit VA1 and the negative voltage output circuit VB1.

The positive voltage output circuit VA1 shown in FIG. 7 may be replaced with the positive voltage output circuit VA2 shown in FIG. 2 and FIG. 4 to FIG. 6, or may be replaced with the positive voltage output circuit VA3 shown in FIG. 3.

The negative voltage output circuit VB1 shown in FIG. 7 may be replaced with the negative voltage output circuit VB2 shown in FIG. 2, the negative voltage output circuit VB3 shown in FIG. 3 or FIG. 4, the negative voltage output circuit VB4 shown in FIG. 5 or the negative voltage output circuit VB5 shown in FIG. 6.

The primary side circuit PRYT3 not only includes a resonant converter RES, but also includes a filter circuit FLT, a bridge rectifier BRG and a power factor correction circuit FCR. The resonant converter RES shown in FIG. 7 may be the same as the resonant converter PR2 shown in FIG. 6.

In practice, the feedback circuit FB, the coupling circuit UL, the resonant control circuit CTR, the protection circuit PRE, the correction control circuit CTN, the filter circuit FLT, the bridge rectifier BRG, the power factor correction circuit FCR or any combination thereof may be replaced with other circuits.

As shown in FIG. 7, in the primary side circuit PRYT3, the bridge rectifier BRG is connected to the filter circuit FLT and the power factor correction circuit FCR, and the resonant converter RES is connected to the power factor correction circuit FCR.

The primary side winding TC1 of the transformer TR is connected to the resonant converter RES. The secondary side winding TC2 of the transformer TR is connected to the positive voltage output circuit VA1 and the negative voltage output circuit VB1.

The feedback circuit FB is connected to the positive voltage output circuit VA1 as shown in FIG. 7, or is connected to the negative voltage output circuit VB1 in practice. The feedback circuit FB and the resonant control circuit CTR are coupled with each other through the coupling circuit UL, which can be such as an optical coupling component.

The resonant control circuit CTR is connected to the resonant converter RES, the power factor correction circuit FCR and the protection circuit PRE. The correction control circuit CTN is connected to the power factor correction circuit FCR.

The filter circuit FLT receives an alternating current (AC) input voltage from the external input power source (that is not shown in figures), and filters the AC input voltage to form a filtered voltage.

The bridge rectifier BRG rectifies the filtered voltage from the filter circuit FLT to output a rectified voltage.

The correction control circuit CTN controls the power factor correction circuit FCR to output a direct current (DC) input voltage to the resonant converter RES according to the rectified voltage from the bridge rectifier BRG. As a result, the positive voltage output circuit VA1 outputs the positive output voltage VOUTP and the negative voltage output circuit VB1 outputs the negative output voltage VOUTN.

In conclusion, the disclosure provides the power supply circuit having the positive and negative output voltages. In comparison with the conventional power converter that is only capable of supplying the positive output voltage, the power supply circuit of the disclosure can supply the positive output voltage and the negative output voltage at the same time. Therefore, the power supply circuit of the disclosure is more widely applicable than the conventional power converter.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the disclosure pertains without departing from its spirit and scope.

What is claimed is:

1. A power supply circuit having positive and negative output voltages, comprising:
a primary side circuit comprising:
a resonant converter;
a transformer, wherein the transformer comprises a primary side winding and a secondary side winding, and the resonant converter is connected to the primary side winding; and
a secondary side circuit comprising:
a positive voltage output circuit connected to the secondary side winding and configured to output a positive output voltage; and
a negative voltage output circuit connected to the secondary side winding and configured to output a negative output voltage.

2. The power supply circuit according to claim 1, wherein the secondary side winding of the transformer comprises a first secondary side subwinding and a second secondary side subwinding;
wherein a first terminal of the first secondary side subwinding is connected to the positive voltage output circuit, and a second terminal of the first secondary side subwinding is connected to ground;
wherein a first terminal of the second secondary side subwinding is connected to ground, and a second terminal of the second secondary side subwinding is connected to the positive voltage output circuit and the negative voltage output circuit.

3. The power supply circuit according to claim 2, wherein the negative voltage output circuit comprises:
a first inverter diode; and
an inverter capacitor;
wherein a cathode of the first inverter diode is connected to the second terminal of the second secondary side subwinding, an anode of the first inverter diode is connected to a first terminal of the inverter capacitor, and a second terminal of the inverter capacitor is connected to ground.

4. The power supply circuit according to claim 3, wherein a voltage of the inverter capacitor is the negative output voltage.

5. The power supply circuit according to claim 3, wherein the negative voltage output circuit further comprises:
a second inverter diode, wherein a cathode of the second inverter diode is connected to the first terminal of the first secondary side subwinding, and an anode of the second inverter diode is connected to the first terminal of the inverter capacitor.

6. The power supply circuit according to claim 2, wherein the negative voltage output circuit further comprises:
a first transistor; and
an inverter capacitor;
wherein a first terminal of the first transistor is connected to the second terminal of the second secondary side subwinding, a second terminal of the first transistor is connected to a first terminal of the inverter capacitor, a control terminal of the first transistor is coupled to a first control voltage, and a second terminal of the inverter capacitor is connected to ground.

7. The power supply circuit according to claim 6, wherein a voltage of the inverter capacitor is the negative output voltage.

8. The power supply circuit according to claim 6, wherein the negative voltage output circuit further comprises:
a second transistor, wherein a first terminal of the second transistor is connected to the first terminal of the first secondary side subwinding, a second terminal of the second transistor is connected to the first terminal of the inverter capacitor, and a control terminal of the second transistor is coupled to a second control voltage.

9. The power supply circuit according to claim 2, wherein the positive voltage output circuit comprises:
a first diode; and
an output capacitor;
wherein an anode of the first diode is connected to the first terminal of the first secondary side subwinding, a cathode of the first diode is connected to a first terminal of the output capacitor, a second terminal of the output capacitor is connected to ground, and a voltage of the output capacitor is the positive output voltage.

10. The power supply circuit according to claim 9, wherein the positive voltage output circuit further comprises:
a second diode, wherein an anode of the second diode is connected to the second terminal of the second secondary side subwinding, and a cathode of the second diode is connected to the first terminal of the output capacitor.

11. The power supply circuit according to claim 1, wherein the power supply circuit further comprises a feedback circuit, a coupling circuit, a resonant control circuit, a protection circuit and a correction control circuit, and the primary side circuit further comprises a filter circuit, a bridge rectifier and a power factor correction circuit;
wherein the feedback circuit is configured to output a feedback signal according to the positive output voltage or the negative output voltage;
wherein the resonant control circuit is configured to receive the feedback signal from the feedback circuit through the coupling circuit and receive a voltage threshold from the protection circuit, and configured to compare the feedback signal with the voltage threshold to control the resonant control circuit;
wherein the filter circuit is configured to filter an alternating current input voltage to form a filtered voltage, the bridge rectifier rectifies the filtered voltage to output a rectified voltage, and the power factor correction circuit is configured to output a direct current input voltage to the resonant control circuit according to the rectified voltage.
